(19) United States
(12) Patent Application Publication
(10) Pub. No.: US 2010/0018328 A1
(43) Pub. Date: Jan. 28, 2010

(54) Magnetic torque/force transducer

(76) Inventor: Lutz A. May, Getling (DE)

Correspondence Address: BLANK ROME LLP, WATERGATE, 600 NEW HAMPSHIRE AVENUE, N.W., WASHINGTON, DC, 20037, US

(21) Appl. No.: 10/498,058

(22) PCT Filed: Dec. 9, 2002
(86) PCT No.: PCT/EP02/13952

§ 371 Date: Oct. 12, 2005

(30) Foreign Application Priority Data
Dec. 10, 2001 (GB) 0129510.4

(51) Int. Cl. G01L 3/02

(52) U.S. Cl. 73/862.193

(57) ABSTRACT

A torque transducer utilizes a ferromagnetic region (20) of a shaft subject to torque (T). A coil (L_{D}), carried on a former (32) within which the region (20) is rotatable, is wound about the region (20). The coil (L_{D}) is energised by a current (I) to induce a magnetic field in region (20) and one or more sensors (23) is position adjacent the region and the coil to detect a torque-dependent tangential (circumferential) field component external to the region (20). The current (I) may be D.C. or A.C. enabling frequency selective detection. The coil (L_{D}) and the sensor (23) are constructed as an integral unit. The sensor (23) is sensitive to axial tilt or skew of the region (20) within the coil (L_{D}). Compensation measures are disclosed. Alternatively the transducer can be configured to provide measurement of skew, tilt or pivotal movement due to a force applied to the shaft or other elongate member.

### FIELD OF THE INVENTION

This invention relates to a magnetic-based torque transducer. The invention also relates to a magnetic-based force transducer. The invention further relates to a transducer assembly. Such an assembly may be adapted for use in a torque or force transducer. The invention also relates to a sensor unit, one application of which, though not exclusively so, is in the measurement of torque while compensating for skew or tilt or vice versa.

### BACKGROUND TO THE INVENTION

Magnetic-based torque transducers have found application in non-contacting torque sensors particularly for a shaft which rotates about its longitudinal axis. A magnetic region is established in or on the shaft which exhibits a torque-dependent magnetic field external to the shaft which is detected by a sensor arrangement that is not in contact with the shaft.

One class of magnetic region used as a transducer element in torque transducers is self-excited in that it is a region of permanent or stored magnetisation which emanates an external torque-dependent field. The transducer region is sometimes referred to as “encoded” in that a predetermined configuration of magnetisation is stored in it. The stored magnetisation may be of the kind known as circumferential in an integral region of a ferromagnetic shaft as disclosed in WO99/56099 or it may be a circumferentially-magnetised ring secured to the shaft as disclosed in U.S. Pat. No. 5,351,555. Circumferential magnetisation forms a closed peripheral loop about the shaft and produces an axially-directed external field in response to applied torque. Another form of stored magnetisation is an integral portion of a shaft in which the stored magnetisation is in an annulus about the axis of the shaft and is directed longitudinally, that is in the direction of the shaft axis. One kind of longitudinal magnetisation is known as circumferential (tangential)-sensing as is disclosed in WO01/13081: another kind is known as profile-shift as disclosed in WO01/79801. The sensor devices used with self-excited transducer elements may be of the Hall effect, magnetoresistive or saturating core (saturating inductor) type. These sensor-devices are sensitive to orientation. They have an axis of maximum response, and an orthogonal axis (plane) of minimum response.

Another class of magnetic transducer region is externally excited by an energised coil wound about the region. One form of externally-excited transducer is the transformer type in which the region couples an excitation winding to a detector winding, the coupling being torque-dependent. For example the permeability of the transducer element may be torque dependent. The transformer-type of transducer is A.C. energised. An example of a transformer-type of transducer is disclosed in EP-A-0321662 in which the transducer regions are specially prepared to have a desired magnetic anisotropy at the surface.

Another form of externally-excited transducer region is disclosed in WO01/27584 in which a pair of coils are mounted coaxially with a shaft in which an applied torque is to be measured. The coils are axially spaced and define a transducer region therebetween. The coils are energised to induce a longitudinal magnetic field of a given polarity. The longitudinal field in the transducer region is deflected in direction and to an extent dependent on torque applied to the shaft to produce an external circumferential (tangential) magnetic field component that is a function of torque. The axially-directed component of the field is separately detected to provide a reference against which the circumferential component is measured. In WO01/27584, the pair of spaced coils is A.C. energised at a frequency selected to be distinguishable from noise frequencies, e.g. mains power frequency, and the sensor output is also detected in a frequency-selective manner. The detection may be synchronous with the A.C. energisation. The external field to be sensed is enhanced by a pair of spaced collars of magnetic material attached to the transducer region to aid the establishing in a recess between the collars of an external component of the longitudinal field in the transducer region. A sensor arrangement responsive to a torque-dependent magnetic field in the circumferential (tangential) arrangement is disposed in the recess.

The just-described transducer has the advantage that the transducer region does not have to be encoded with a stored magnetisation. Nonetheless a transducer region has to be defined between a pair of spaced coils. It would be advantageous to provide a transducer assembly in which no encoding is required and which could be realised in compact form and installed at any convenient location on a shaft or other part subject to torque.

### SUMMARY OF THE INVENTION

One aspect of the present invention has arisen out of the consideration that if a coil is placed about a ferromagnetic shaft subject to torque and the coil energised with current, a magnetic field will be induced, at least in an annular zone of the shaft adjacent the surface. This field will be generally axially-directed. Such a field in the region of the shaft where the coil is located is distorted by a torque to generate a magnetic field component in the circumferential (tangential) direction whose magnitude and direction are dependent on the magnitude and direction of the torque. Although the magnetic field is, primarily generated in the shaft region within the coil, sufficient external field exhibiting the desired torque-dependent characteristic is found closely adjacent each end of the coil and can be detected by a sensor located close in to the coil. The external diameter of the shaft should be a close match to the internal diameter of the coil, which may be supported on a former, enabling the field generated by the coil to penetrate the shaft while allowing the shaft to rotate within the coil. In addition a second sensor can be located to detect a field component generated by the coil such as a longitudinal or axially-directed component, which is unaffected or substantially so, by torque. The signal from the second sensor can be used to develop a reference signal against which the torque-dependent field component is measured.

Another aspect of the present invention has arisen out of the consideration that if a coil is placed about a ferromagnetic elongate member subject to a force transverse to the axis of the member and the coil is energised with current, a magnetic field will be induced, at least in an annular zone of the shaft adjacent the surface. This field will be generally axially-directed. Such a field in the region of the member where the coil is located is distorted by a transverse force applied to the elongate member, the force acting to tilt or skew the axis of the elongate member relative that of the coil. The force results in the generation of a magnetic field component in the circumferential (tangential) direction whose magnitude and direction are dependent on the magnitude and direction of the tilt or skew and thus of the force which gave rise to it. Although the magnetic field is primarily generated in the region of the elongate member within the coil, sufficient external field exhibiting the desired-force dependent characteristic is found closely adjacent each end of the coil and can be detected by a sensor located close in to the coil. The external cross-section of the elongate member should be a sufficiently close match to the internal cross-section of the coil, which may be supported on a former, to enable the field generated by the coil to penetrate the shaft while allowing the elongate member to tilt or skew (flex) within the coil. The elongate member may be subject to a bending moment due to an applied force. Alternatively it could be pivotally mounted to allow angular displacement about the pivot in response to an applied force. In addition a second sensor can be located to detect a field component generated by the coil, such as a longitudinal or axially-directed component, which is unaffected, or substantially so, by the force being measured. The signal from the second sensor can be used to develop a reference signal against which the force-dependent field component is measured.

Aspects and features of the present invention are set forth in the claims following this description.

### BRIEF DESCRIPTION OF THE DRAWINGS

The invention and its practice will be further described with reference to the accompanying drawings, in which:

FIG. 1 schematically shows a shaft to which is mounted a transducer assembly of the invention;

FIG. 2 illustrates the detectable external magnetic field generated by the energised coil of the assembly of FIG. 1;

FIG. 3a shows a perspective view of a transducer comprising a unitary transducer assembly mounted on a shaft with a sensor device at each side of the coil;

FIG. 3b is a schematic illustration of the transducer of FIG. 3a with the addition of a reference sensor device;

FIG. 4 illustrates a sensor arrangement with two inductive-type sensor devices (saturating core sensors) arranged to provide cancellation of an extraneous field;

FIG. 5 shows a sensor arrangement of four sensors providing cancellation of extraneous fields;

FIG. 6 schematically shows an A.C. energised transducer system embodying the invention; and

FIG. 7 illustrates factors to be considered relating to movement of the shaft relative to the transducer assembly.

FIG. 8 illustrates one sensor arrangement for reducing the sensitivity to axial skew or tilt of the transducer assembly relative to the axis of the transducer region;

FIG. 9 illustrates one embodiment using a transducer of the invention in the measurement of a force by utilising the sensitivity to tilt or skew;

FIG. 10 illustrates a second embodiment for the measurement of a force;

FIG. 11 shows an implementation of the force-measuring embodiment of FIG. 9 or 10 in measuring tension in a running thread or other similar lengthwise-moving flexible item; and

FIG. 12 shows a modification of the transducer assembly including further coils to reduce the possibility of establishing remnant magnetisation in the transducer region.

### DESCRIPTION OF PREFERRED EMBODIMENTS

In the figures, like reference numerals indicate like parts.

### Torque Measurement

FIG. 1 shows a shaft 10, which is assumed to be of circular cross-section and which is mounted for rotation about its longitudinal axis A-A. The shaft may continuously rotate, rotate over a limited angular range, or even be held at one end while torque is applied at the other. Torque T is shown as applied at end 12 to drive a load (not shown) coupled to end 14.

A coil L_{D} is mounted about a region 20 of the shaft which is to act as a transducer region for measuring torque in the shaft. At least the transducer region of the shaft is of ferromagnetic material. The transducer region should have an axial length sufficient for the establishment of the desired field within the material of the shaft and allowing for axial displacement of the shaft with respect to the coil as may occur in some practical applications. The region 20 is indicated by the dash lines which are notional limits. The coil L_{D} is a helical coil, single or multi-layer, coaxial with shaft axis A or it may be pile wound on a former. The coil is energised by a source 22 about which more is said below. At least one sensor device 23 is mounted closely adjacent the coil L_{D} and region 20, that is the device 23 is closely adjacent the axial hollow in the coil in which the shaft is received. The device 23 is oriented to have its axis of maximum sensitivity in a tangential or circumferential direction. At least one sensor device 24 is mounted adjacent the coil to have its axis of maximum sensitivity in the axial or longitudinal direction. The functions of sensors 23 and 24 correspond to the sensors 23 and 24 respectively seen in FIG. 8a of WO/27584. The sensors may be of the Hall-effect or magnetoresistive type but preferably are of the saturating core (saturating inductor) type connected in a signal-conditioning circuit such as disclosed in published PCT application WO98/52063. The saturating core sensors have a figure-of-eight response the maximum of which is along the core axis and the minimum of which is perpendicular to this axis. The three-dimensional response is the rotation of the figure-of-eight about the axis of maximum sensitivity. The source 22 which energises the coil L_{D} may be D.C. or A.C. as discussed more fully below. Preferably the source is adjustable to control the level of energisation of coil L_{D}.

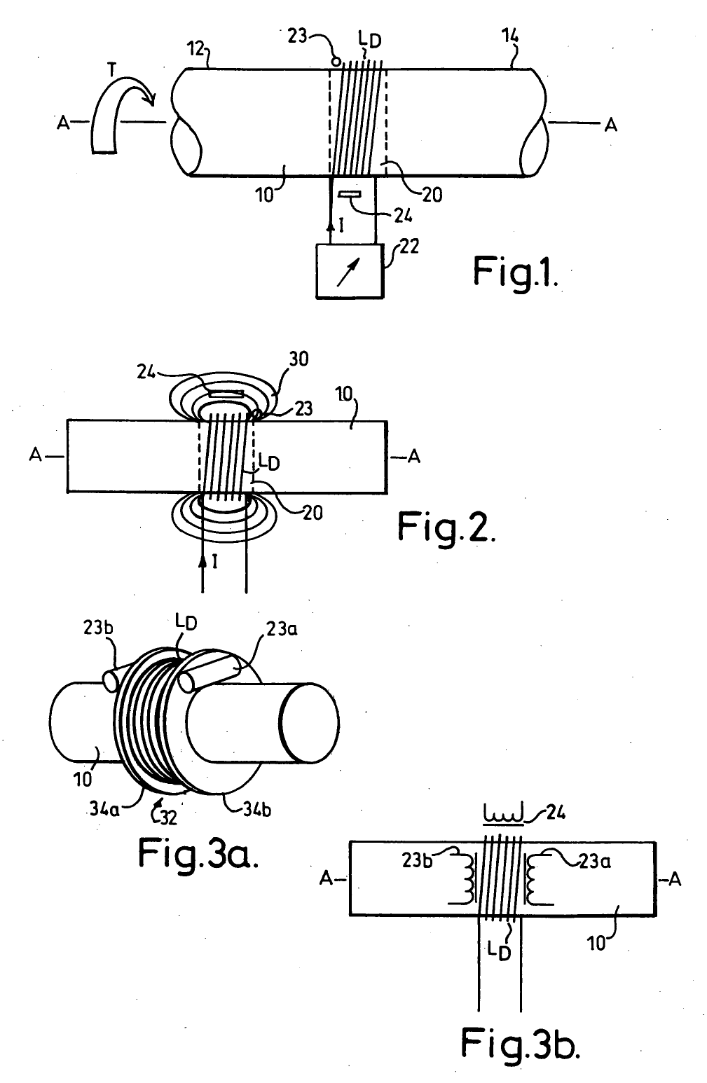

WO01/27584 discloses in FIG. 8a thereof, how a longitudinal field is generated between two spaced coils wound about a shaft. The transducer region is in the zone between the two coils. In contrast, in the embodiment of FIG. 1 the transducer region lies within and extends somewhat beyond the excitation coil L_{D}. FIG. 2 shows the general form of the external field 30 generated by a current I applied in coil L_{D}. It extends in an annulus about axis A-A. It will extend in an annulus of axially-directed magnetisation (longitudinal magnetisation) within the transducer region 20. The annulus extends inwardly from the shaft surface. The internal field is not shown in FIG. 2. For best results the coil L_{D} should couple as closely as possible to the ferromagnetic transducer region 20. The coil may be wound on a former that closely fits over the shaft 10, while allowing rotation of the shaft within the former. It has been found that the field 30 close in to the coil L_{D} and closely adjacent the region 20 is torque-sensitive and provides a tangentially-directed component under torque whose polarity and magnitude are dependent on the direction and magnitude of the torque applied about axis A-A. The sensor 23 is positioned to be responsive to this tangentially-directed component. The sensor 24 is positioned to provide a signal representing the overall level of field generated by coil L_{D} preferably an axial component that is substantially unaffected by torque.

The degree of adjacency of the sensor 24 (or multiple sensors where used) is not a precisely defined parameter. The sensor can be positioned axially with respect to the coil at any point at which a sufficient torque-dependent magnetic field component is detectable. This will be dependent on the energising current in the coil, the material and magnetic properties of the transducer region, and the sensitivity of the sensor. In general the sensor should be mounted close to the transducer region surface and to the coil. However where the generated magnetic field is strong, it may also be necessary to take account of any overload characteristic of the sensor(s) being used.

FIG. 3a shows a perspective view of a shaft 10 on which is mounted a close-fitting former 32 on which the coil L_{D} is wound. The former 32 has end cheeks 34a and 34b closely adjacent to which and the shaft surface are mounted sensor devices 23a and 23b with their axes of maximum sensitivity tangential to the shaft. The arrangement is shown schematically in FIG. 3b in which the devices 23a and 23b are represented as inductances wound on saturating cores. As already indicated, the coil 24 can be mounted in the vicinity of the coil L_{D} at any point where there is an axially-directed field component from which a reference signal can be generated against which the torque-dependent signals from sensors 23a, 23b can be measured or, put another way, which is used to control the gain of the transducer.

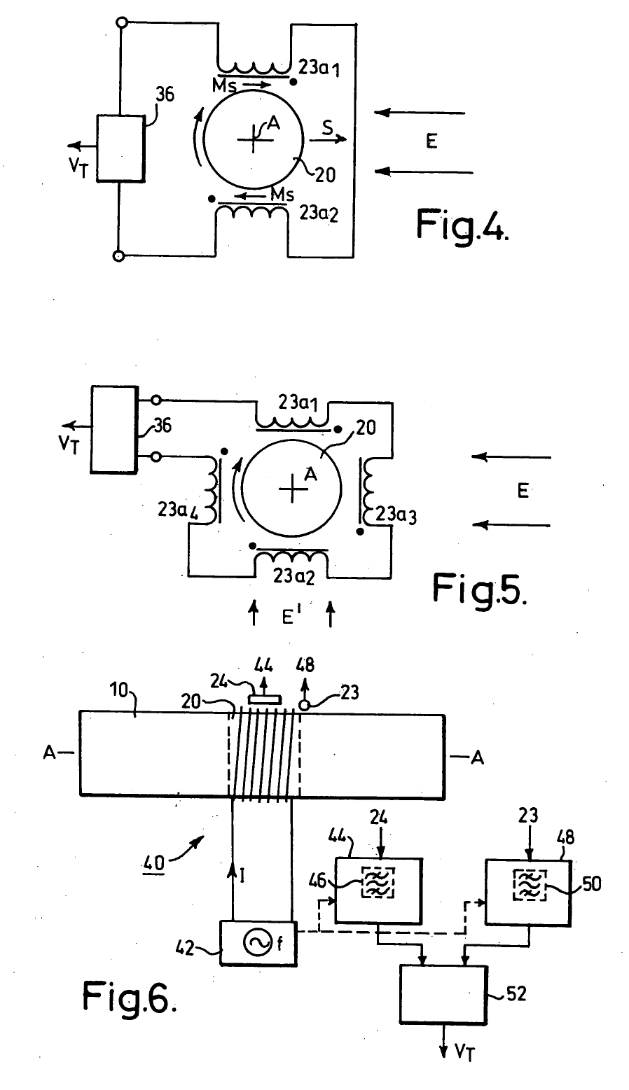

FIG. 4 shows how each sensor device 23a, 23b can be provided as a sensor arrangement comprising a pair of radially-opposite sensor devices. FIG. 4 shows a cross-section through transducer region 20 and shows the sensor device 23a as now being a sensor arrangement comprising a pair of devices 23a1 and 23a2 mounted on opposite sides of the transducer region 20 of shaft 10, i.e. diametrically opposed with respect to axis A-A. The remainder of the transducer assembly is not illustrated. In the cross-sectional view of FIG. 4 the torque-dependent field components are denoted Ms and are oppositely directed on diametrically opposite sides of region 20 so that the respective device coils 23a1 and 23a2 are connected in series additively as regards the torque-dependent components Ms but are connected subtractively to cancel an external field E acting on both sensor devices in common. The sensor devices 23a1 and 23a2 are connected in series to a signal-conditioner circuit 36—such as that disclosed in WO98/52063 above-mentioned—from which is obtained a torque-representing output signal, V_{T}.

The shaft 10 may be subject to a bending moment causing a deflection of it at the transducer region 20 from the axis A-A. The shaft may also be subject to some wobble of its axis in its rotation. If the shaft deflects perpendicularly to the direction of arrow S, that is toward one of the sensor devices and away from the other, the one device will provide a larger signal output than does the other. Because the outputs are additively connected, such a deflection will be compensated, at least to some extent. The compensation is not exact because the field strength sensed by the devices is a square law function of distance from the shaft surface. But normally such deflections are expected to be small and a high degree of compensation is afforded.

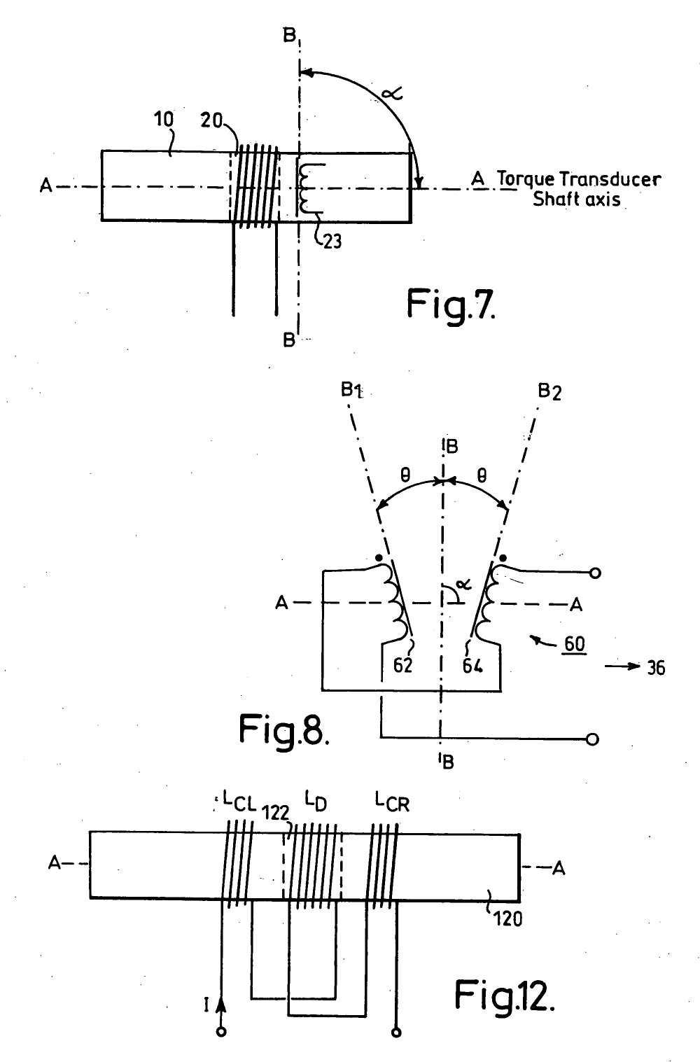

If the deflection is in the direction of (or opposite to) the arrow S, provided that it is small and within the lateral sensing extent of the sensor devices i.e. not resolvable by the devices, the combined signal output will not be affected. As the deflection increases, each sensor device 23a1, 23a2 yields a lesser torque signal output. However, there is also a signal generated in each device due to the deflection itself even if the shaft is not rotating. The deflection is a common mode effect and is cancelled by the connection of the two devices. This subject is further discussed below with particular reference to FIG. 7.

The sensor arrangement disposed adjacent one end of the coil L_{D} can be extended further. For example FIG. 5 shows an additional pair of sensor devices 23a3 and 23a4 mounted diametrically radially opposite one another with respect to transducer region 20 and orthogonally with respect to devices 23a1 and 23a2. Devices 23a1 and 23a2 are additively connected with one another, and with devices 23a1 and 23a2 as regards the torque-dependent field components but are subtractively connected with respect to a magnetic field component E′.

It will be appreciated that the same use of one or more pairs of sensor devices can be adopted for sensor device 23b of FIGS. 3a and 3b. It will also be noted that it is not necessary for the sensor devices 23a and 23b, or the more complex sensor arrangements thereof, to be aligned in angular disposition about the shaft. It will be also appreciated that each sensor device can be connected into a respective detection circuit and the outputs of the individual circuits combined as required.

The description of the practice of the invention thus far has assumed a D.C. energisation of the coil. This leads to what may be called a D.C. magnetic field. For reliability of response in using a D.C. field, it is desirable that the shaft 10 be subject to a de-gaussing or magnetic cleansing procedure as is described in above-mentioned WO01/79801. In the sensor arrangements discussed above, the adoption of a D.C. magnetic field leads to the fastest torque-signal response with the circuitry currently in use. That is the overall circuitry exhibits the highest bandwidth for signal changes. However, A.C. magnetisation may also be employed. A.C. energisation has some advantages but also entails consideration of other factors. An A.C. transducer system 40 is illustrated in FIG. 6 and may be compared to that shown in FIG. 12 of WO01/27584. An A.C. source 42 energises coil L_{D} at a frequency f. The source may be a bipolar pulse source. A signal conditioner circuit 44 connected to sensor arrangement 24 is provided with a filter function 46 to extract the magnetic field component at frequency f detected by sensor arrangement 24. The filter may be driven from the source 42 to ensure the filter 46 tracks the source frequency f as is indicated by the chain line. Synchronous detection in which a detector in circuit 44 is driven by a signal from source 42 may be employed. Similarly the sensor arrangement 23 is connected into a frequency-selective signal conditioner circuit 48 including filter function 50 to provide an output representing the torque-dependent field component. This component together with a reference level component obtained from circuit 44 is applied to a signal processing circuit 52 from which a torque-representing output V_{T} is obtained. It will be understood that the filtering and signal-processing functions may be performed in hardware or software and that the filtering may be performed at various points in the complete signal path. It is desirable that the operating frequency f of the source/filter system be selected to be well-distinguishable from frequencies of potential interfering sources, e.g. power (mains) frequency.

Saturating-core types of sensor are capable of operating up to 10 kHz or more but in addition to the sensor response consideration has to be given to the source frequency response in its ability to drive the coil L_{D}. There is another frequency-dependent characteristic to be considered, particularly when the transducer region is an integral portion of a shaft.

The depth of penetration of the coil field into the material of the transducer region is frequency-dependent. It is greatest at zero frequency, i.e. D.C., and decreases as the drive frequency increases. For example, a shaft of FV250B steel of a diameter of 18 mm, was penetrated entirely by a D.C. energised coil but was not entirely penetrated by the equivalent A.C. current at 100 Hz. Penetration of the entire cross-section of the transducer region is not essential as the torque-dependent response tends to be concentrated in a surface-adjacent annular zone. However, as the frequency increases it is found that the gain or slope of the transfer function—the torque-dependent signal output v. applied torque—will have a tendency to decrease.

The transducer and transducer assembly described above provides the following benefits:

the assembly of coil (with former) and sensor arrangement or arrangements can be manufactured as a unitary component mountable to a shaft; the unitary structure may also comprise signal conditioning and processing circuitry;

the manufacturing process does not require any encoding procedure for the transducer region to establish a permanent magnetisation therein; in a homogeneous shaft, there is freedom as to where the transducer region is to be established and there is no critical aligning of the transducer assembly with a predetermined region of the shaft.

there is no degradation of the magnetisation of the transducer region over time as can occur with a permanent magnetisation;

the gain or slope of the transfer function of the transducer is a function of the drive current to the transducer coil. It has been found that short of energisation current levels creating a non-linear response, response sensitivities are obtainable substantially greater than achievable by the aforementioned profile-shift magnetisation;

the transducer is insensitive to axial displacement of the transducer region with respect to the transducer coil/sensor assembly;

the ability to operate in an A.C. fashion at a selected frequency allows operation within a noisy environment and renders the transducer more tolerant of stray magnetisms in the shaft.

Another factor to be considered for both D.C. and A.C. implementations of the invention is illustrated in FIG. 7 which shows the shaft 10, energising coil L and a sensor device 23 oriented to detect a tangential torque-dependent component. The axis B-B maximum sensitivity of a sensor device 23 is oriented at an angle of α to the axis A-A of the shaft. Axis A-A lies in the plane of the figure, axis B-B is parallel to and above the plane of the figure. Angle α is thus the angle between axis B-B as projected onto the plane of the figure and is ideally 90°. As compared to some forms of permanently-magnetised transducer regions, the transducer assembly embodying the invention is not sensitive to axial shifts of the transducer region, assuming the transducer region is bounded by shaft material homogeneous therewith as would be the case with a shaft homogeneous along its length with which the transducer region is integral. However, the operation of the transducer assembly (coil plus sensor arrangement) is sensitive to axial skewing or tilting of the shaft relative to the assembly that affects the angle α.

Attention will now be given to the sensitivity to axial skewing and measures to mitigate it. It will also be shown that conversely a transducer-assembly embodying the invention can be implemented to use axial skewing in an advantageous manner to enable a measurement of a force to be made.

Referring again to FIG. 7, consider the situation where there is no torque in the shaft 10 but the shaft axis tilts relative to the axis of coil L_{D} so that the angle α is no longer 90°. The coil is energised.

The result is a transverse component of the magnetic field generated by the coil L_{D} which is detected by sensor device 23. If a sensor arrangement such as shown in FIG. 4 is employed the skewing, indicated by arrow S, will be in the same direction relative to both sensors 23a1 and 23a2. As regards the detected field, the skew acts as a common mode component and is cancelled in the output similarly to the common external field E. This common mode rejection is equally obtained when the shaft is under torque. When under torque a skew orthogonal to arrow S will tend to increase the component M_{S} at, say, sensor device 23a1 and decrease component M_{S} at sensor 23a2 with little effect on the combined output signal V_{T}. This is true generally of wobble of the shaft 10 in its rotation. This foregoing reasoning can be extended to the sensor arrangement of FIG. 5 with reference to a skew orthogonal to direction S.

Another approach can be adopted to making an individual sensor such as 23 in FIG. 7 less sensitive to skew. This is illustrated in FIG. 8 in which the single sensor device 23 is shown as being replaced by a sensor unit 60 comprising a pair of devices 62 and 64. The shaft as such is not shown but its axis A-A is indicated. B-B is the axis of response of sensor 60, desirably at an angle α=90° to axis A-A. The two sensor devices are offset at an angle θ to each side of axis B-B, that is their respective axes B₁, B₂ maximum sensitivity are separated in a “V” formation by angle 2θ.

In measuring a torque-dependent field component, which affects both sensor devices substantially equally, if there is a tilt—α moves from 90°—the field sensed by one device increases while the field sensed by the other decreases. If the two devices are connected additively, dot to non-dot end, to a signal conditioning and processing circuit 36 of the kind indicated in FIG. 1, the resultant signal is far less affected by angular skew or tilting than that of a single device, particularly for small deviations of α from 90°. This would normally be the case. The angle of deviation should not exceed the angle θ.

### Force Measurement

The immediately preceding discussion has been concerned with measuring torque in the presence of an angular tilt or skew of the shaft relative to the transducer coil assembly and its associated sensors. One circumstance in which such a skew or tilt may arise is if the shaft, the torque in which is to be measured, is subject to a transverse force leading to a bending moment in the shaft at the location of the transducer region. The sensitivity to any resultant axial tilt or skew, in the absence of compensatory measures, can be utilised to measure the applied force. Furthermore, this force measurement is not restricted in its application to a shaft in which a torque is transmitted. The force measurement can be applied to any elongate member subject to a bending moment due to an applied force or even an elongate member pivotally mounted to turn about the pivot axis (or mounted so as to effectively turn in such a manner) in response to an applied force. The elongate member is to be capable of supporting or having incorporated into it a transducer region with a transducer assembly as has been described above but with a modified sensor arrangement.

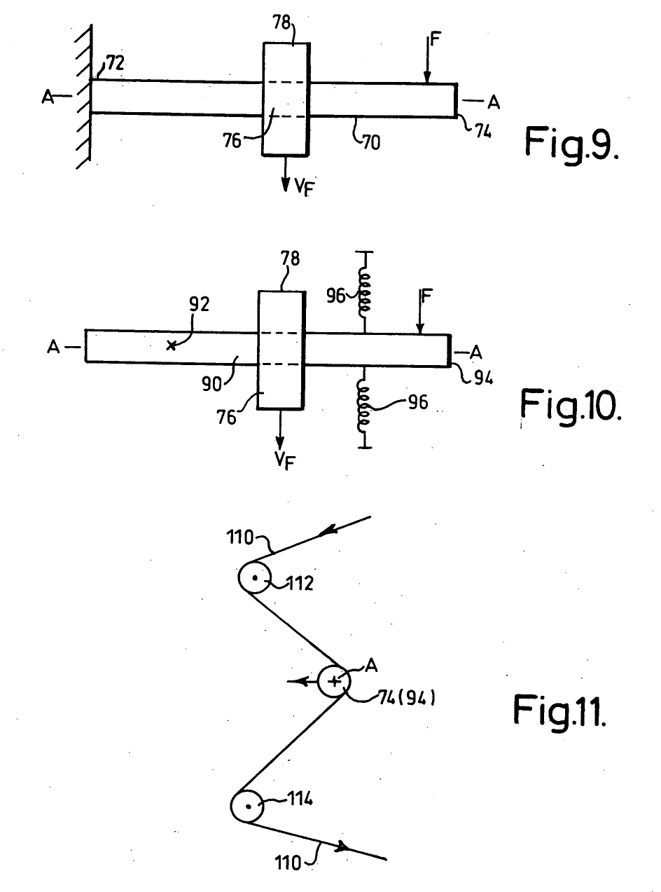

FIG. 9 shows an elongate member 70 which is fixed at one end 72 and the other end portion 74 of which is free to move under a force F applied transversely of a longitudinal axis A-A of member 70. The member 70 is resilient and relatively stiff so that it yields to the bending moment impressed by the force F to deflect at an intermediate region 76 to an extent which is function of the applied force. The intermediate region 76, at least, is of ferromagnetic material and provides a transducer region for a transducer assembly 78 comprising an excitation coil about region 76 and a sensor arrangement configured to respond to the deflection of the member 70 with respect to the axis of the coil of transducer assembly which remains aligned with the axis A-A of the unstressed member 70 with no force F applied to it. The transducer assembly is constructed as previously described and with particular reference to the detection of tilt or skew. The effect of the deflection of the elongate member is that of the angular tilt or skew already described, where the shaft 10 is no longer a torque transmitting part but is now replaced by the deflectable elongate member 70.

By way of example, if the sensor arrangement in assembly 78 of FIG. 9 uses a pair of diametrically opposite sensor devices as shown in FIG. 4, consider a connection of the sensor devices 23a1 and 23a2 to circuit 36 in which one of the devices is now reverse connected, e.g. dot end to dot end, the connection does not cancel the skew or tilt S due to force F in FIG. 9 but adds the contributions from the sensor devices due to S to provide the force-representing signal V_{F} in FIG. 9 If the circumstances were such that it was desired to measure the skew or tilt S of the shaft 10 without interference by the torque in the shaft, it will be seen that the reversal of the connection of the sensor devices 23a1 and 23a2 in FIG. 4 not only provides an additive response to skew or tilt but cancels the torque components M_{S}.

A transducer assembly 78 of FIG. 9 having the coil arrangement of FIG. 8 can be also adapted to measure the force dependent deflection of member 70 by reversing the connection of one sensor device so that the devices 62 and 64 are, for example, connected dot end to dot end. The output now obtained represents the tilt angle θ.

While FIG. 9 shows the use of an elongate member the resilience of which resists the applied force F and the resultant bending moment in which causes the measurable skew or tilt, the equivalent result could be achieved by the modification shown in FIG. 10 in which an arm 90 pivotally mounted at 92 to pivot in the plane of the figure has the force F to be measured applied at its free end 94. The force is resisted by resilient means 96, such as a spring or a magnetic-force restoring means which is particularly usable where the whole arm 90 is of ferromagnetic material. With zero force F applied the axis A-A of the arm 90 is aligned with the axis of the transducer assembly constructed as described above to provide the force-representing signal V_{F}.

An example of the application of the invention to the measurement of a force or bending moment is illustrated in FIG. 11. This figure illustrates a system for measuring the tension in a running thread such as found in a weaving or other textile machine. The system employs a force measurement transducer as shown in FIG. 9 or FIG. 10.

In FIG. 1 the thread 110 moves in a path over pulleys or rollers 112 and 114 between which the path is angled into a V-shape by the offset introduced by the end portion 74 (94) of the elongate member 70 (90) of FIG. 9 (10) which is mounted to have its axis A-A at least substantially normal to the plane of the drawing. The end portion 74 (94) may be configured to allow free running of the thread over it. The angle introduced into the thread path by portion 74 (94) results in a force F being exerted on portion 74 (94) which is measured by the transducer of FIG. 9 (10) as described above.

FIG. 12 illustrates a modification of the embodiments of the invention described above in which provision is made to prevent the creation of a bar magnet in the shaft or elongate member in which the transducer region is incorporated. This applies particularly to D.C. energised transducers but may also be applied to reduce the likelihood of residual magnetisation occurring in A.C. energised transducers.

FIG. 12 shows a shaft or elongate member 120 on which an excitation coil L_{D} is mounted about transducer region 122. The sensor arrangement is not shown. To each side of coil L_{D} a respective coil L_{CL} and L_{CR} is mounted. The coils L_{CL} and L_{CR} are energised at the same time as coil L_{D}, as by being connected in series therewith as shown in FIG. 12, and generate fields of opposite polarity to that generated by coil L_{D}. The coils L_{CL} and L_{CR} are sufficiently spaced from coil L_{D} to allow the desired transducer region field to be generated in the vicinity of coil L_{D} and sensed in the manner already described.

More specifically, each of the three coils produces an individual field as shown in FIG. 2. Taking coil L_{CL} as an example the field toward coil L_{D} is of the same polarity as that of coil L_{D} towards coils L_{CL}, i.e. the fields tend to repel one another. An equivalent situation arises between coils L_{D} and L_{CR}. The coils L_{CC} and L_{CR} should not be so close to coil L_{D} as to adversely affect the torque- or force-dependent field which it is sought to measure. The effectiveness of the coils L_{CL} and L_{CR} in reducing the formation of a bar magnet in shaft or elongate member 120 may be judged by a sensor located to detect the axial field extending outwardly of a coil L_{CL} or L_{CR}. This field should be reduced to substantially zero. Experiments have shown that such a result can be achieved by having the coils L_{CL} and L_{CR} generate half the ampere-turns of coils L_{D} so that for the series connection shown with a common current, coils L_{CL} and L_{CR}, have half the number of turns of coil L_{D}.

The shaft or elongate member in which the transducer region is created may be subject to a degaussing procedure prior to being put into use. Such a procedure is described in published PCT application WO01/79801.

1. A transducer comprising: a shaft mounted for the application thereto of torque about a longitudinal axis of the shaft, at least a region of said shaft being of ferromagnetic material; a coil mounted about said region and energisable to induce an axially-directed magnetisation in said region; at least one sensor device mounted adjacent said coil and said region, said sensor device being oriented to detect a tangentially (circumferentially)-directed component of magnetic field external to said region.

2. A transducer comprising: an elongate member mounted for the application thereto of a force causing the elongate member to tilt or skew angular about a longitudinal axis thereof; the elongate member having at least a region of ferromagnetic material in which the tilt or skew is evinced; a coil mounted about said region and energisable to induce an axially-directed magnetisation in said region; at least one sensor device mounted adjacent said coil and said region, said sensor device being oriented to detect a tangentially (circumferentially)-directed component of magnetic field external to said region.

3. A transducer as claimed in claim 2 in which said elongate member is pivotally mounted at a point exterior to said region to allow the member to undergo pivotal movement within said coil.

4. A transducer as claimed in claim 1 in which said coil and said at least one sensor device are comprised in a unitary transducer assembly.

5. A transducer according to claim 1 in which said coil has a respective further coil axially to each side thereof and connected to be energised to produce a magnetic field of opposite polarity to that of said coil about the transducer region.

6. A transducer assembly comprising: a coil wound about an axis and having an axial hollow therethrough, said coil being energisable to generate an axially-directed magnetic field in a ferromagnetic portion of a shaft or other elongate member receivable in said hollow; at least one sensor device disposed adjacent an end of said coil and said hollow for detecting a magnetic field component associated with a portion of ferromagnetic material received in said hollow, said sensor device being oriented to detect a magnetic field component in a tangential (circumferential) direction with respect to said axis.

7. A transducer assembly as claimed in claim 6 in which said coil and said at least one sensor are a unitary assembly.

8. A transducer assembly according to claim 4 comprising first and second further coils each wound about an axis coaxial with the first-mentioned coil and having an axial hollow therethrough, the first mentioned coil and said first and second further coils being disposed in alignment along a common axis with the first-mentioned coil between and spaced from said first and second further coils to receive a ferromagnetic portion of a shaft or other elongate member to extend through all three coils.

9. A transducer assembly as claimed in claim 8 in which all three coils are connected in series such that said first and second further coils are energisable to generate magnetic fields of opposite polarity to that generated by the first-mentioned coil.

10. A sensor unit for detecting a magnetic field comprising first and second sensor devices each having a respective axis of maximum sensitivity for detection of a magnetic field, said first and second sensor devices being arranged to have their respective axes of maximum sensitivity at an angle to one another for providing a combined axis of response which lies within, and preferably bisects, said angle.
